(19) United States
(12) Patent Application Publication
(10) Pub. No.: US 2007/0134808 A1
(43) Pub. Date: Jun. 14, 2007

(54) Simultaneous multi-column liquid chromatograph for direct sampling of an array of liquid samples

(76) Inventor: James T. Sullivan, Newark, DE (US)

Correspondence Address: PACIFIC RING SERVICES, INC., 1143 CHRISTINA MILL DRIVE, NEWARK, DE, 19711, US

(21) Appl. No.: 10/563,266

(22) PCT Filed: Jul. 29, 2004
(86) PCT No.: PCT/US04/24423

§ 371 Date: Apr. 12, 2006

Related U.S. Application Data
(60) Provisional application No. 60/491,008, filed on Jul. 29, 2003.

(51) Int. Cl. G01N 1/10

(52) U.S. Cl. 436/180

(57) ABSTRACT

An apparatus and method for transferring one or more liquid samples in one or more sample containers to one or more measurement devices. The invention provides a sample transfer device that is small enough to be mounted over a microtiter plate in an array for simultaneous sampling. In a preferred embodiment, each sample transfer device in an array can communicate with a well of the microtiter plate simultaneously, such that in one or more cycles of operation, all of the samples in the wells in the microtiter place can be chemically analyzed. In the invention, the functions of valve actuator, sampling valve, syringe pump, and transfer device in a liquid chromatograph are all integrated into a single injector mounted at the end of the chromatographic column.

This application claims priority to U.S. Patent Application No. 60/491,008 filed Jul. 29, 2003, the entire contents and substance of which are hereby incorporated in total by reference.

### BACKGROUND OF THE INVENTION

1. Field of the Invention

This invention relates to separation-based chemical analyses of liquid samples, e.g., via liquid chromatography or electrophoresis.

2. Description of Related Art

Liquid chromatography is a vitally important technique used by scientists to identify unknown components in a sample. Chromatography in general is a separations method that relies on differences in partitioning behavior between a flowing mobile phase and a stationary phase to separate the components in a mixture. Typically, a chromatographic column holds the stationary phase and the mobile phase carries the sample through it. Sample components that partition strongly into the stationary phase spend a greater amount of time in the column and are separated from components that stay predominantly in the mobile phase and pass through the column faster. As the components elute from the column, they can be quantified by a detector and/or collected for further analysis. A chromatographic instrument is generally combined with a detection means for real-time analysis.

Liquid chromatography, more particularly, is an analytical chromatographic technique that is useful for separating ions or molecules that are dissolved in a solvent. If the sample solution is in contact with a second solid or liquid phase, the different solutes will interact with the other phase to differing degrees due to differences in adsorption, ion-exchange, partitioning, mobility or size. These differences allow the mixture components to be separated from each other by using these differences to determine the transit time of the solutes through a column. Simple liquid chromatography consists simply of a column with a fritted bottom that holds a stationary phase in equilibrium with a solvent. Typical stationary phases (and their interactions with the solutes) include solids (adsorption), ionic groups on a resin (ion-exchange), liquids on an inert solid support (partitioning), and porous inert particles (size-exclusion). In this simple column chromatograph, the mixture to be separated is loaded onto the top of the column followed by more solvent. The different components in the sample mixture pass through the column at different rates due to differences in their partitioning behavior between the mobile liquid phase and the stationary phase. The compounds are separated by collecting aliquots of the column effluent as a function of time.

Analytical separations of solutions for detection or quantification typically use a more sophisticated technique known as High-Performance Liquid Chromatography (“HPLC”). HPLC instruments consist of a reservoir of mobile phase, a pump, an injector, a separation column, and a detector. In a simple HPLC instrument, solid compounds may be separated by injecting a plug of the sample mixture onto the column. The different components in the mixture pass through the column at different rates due to differences in their partitioning behavior between the mobile liquid phase and the stationary phase. The pumps provide a steady high pressure with no pulsating, and can be programmed to vary the composition of the liquid phase (typically a solvent) during the course of the separation. Liquid samples are conventionally introduced into a sample loop of an injector with a syringe. When the loop is filled, the injector can be injected the sample into the stream by placing the sample loop in line with the mobile phase tubing. The presence of analytes in the column effluent is recorded by detecting a change in refractive index, UV-VIS absorption at a set wavelength, fluorescence after excitation with a suitable wavelength, or electrochemical response. Mass spectrometers can also be interfaced with liquid chromatography to provide structural information and help identify the separated analytes.

In addition, the analysis of multiple chemical samples stored in arrays, as in microtiter plates, has become common. This arrangement is commonly used, for example, for analyses of large numbers of chemical samples in the pharmaceutical industry. Chromatographic and electrophoretic instruments have been widely adopted for use with such arrays of liquid samples.

FIG. 1 depicts an example of a prior art HPLC system used with samples in a conventional microtiter plate. In such a system, the samples to be analyzed are contained in a microtiter plate or “microplate” 20 having a rectangular array of recesses or wells 21. A syringe 30 is used to draw predetermined units of a liquid sample and deliver them to injection valves 6 at a first valve position 26 and a second valve position 27. The syringe 30 comprises a syringe needle 31, a syringe moving means 34 by which the liquid-tight plunger 32 can be moved within the syringe barrel 33, causing liquid to be sucked into the syringe 30 or to be expelled. In this conventional HPLC system, microplate 20 has a series of wells 21 for the purpose of containing liquid samples 22. An automated mechanism, not shown, moves the syringe to a microplate position 23 so that the syringe needle 31 comes in contact with a liquid sample 22. The syringe system then aspirates a certain volume of the liquid sample 22

The system shown in FIG. 1 further includes multiple valves 3 suited to injecting liquid samples into HPLC analysis systems. Each valve 3 comprises a sampling loop 4 a valve exit tube 11 and a port 6 suitable for receiving a syringe needle. The syringe 30, which contains a certain amount of sample, is moved to a first valve position 26, where the syringe needle 31 is engaged in a port 6 so that a liquid sample can be injected into a sampling loop 4 with any excess, passing through the loop 4 and out a vent exit tube 12. The plunger moving means 34 causes the plunger 32 to expel the liquid into the loop 4.

For each valve 3 there is a pump 1 and a delivery tube 2 that delivers a liquid flow to the valve 3. From each valve 3, a transfer tube 5, a chromatographic column 7, a column exit tube 8, a detector 9, and a detector exit tube 12 carries a liquid flow out of the valve 3. When a valve 3 is caused to change its state (typically via an electrical solenoid), the loop 4 is inserted into the flow path between delivery tube 2 and transfer tube 5 so that the contents of the loop 4 including liquid sample injected by the syringe 30 are swept through the transfer tube 5 to the chromatographic column 7.

The constituents of the liquid sample travel through the column at different rates. The effluent from the column 7 flows through column exit tube 8 to a detector 9. The detector 9 is configured to measure the concentration of chemical samples in the liquid a continuous record of the varying level of concentration. Such record indicates three things: a variation in the measurement indicates the presence of various chemicals in the sample; the times of the variations indicate the identities of said chemicals; and the intensities of the variations indicate the concentration of the chemicals.

It is further known to combine several chromatographic systems of the type shown in FIG. 1 into a “multi-HPLC” analyzer. In such an analyzer, the syringe 30 delivers samples consecutively from the microplate to several chromatographic systems. For instance, the syringe 30 after delivering a sample from first microplate position 23 to first valve position 26 can deliver another sample from second microplate position 24 to a second valve position 27. In a multi-HPLC analyzer, there is a multiplicity of pumps 1 delivery tubes 2 valves 3 transfer tubes 5 columns 7 and detectors 9. In addition, in conventional multi-HPLC analyzers, multiple syringes, rather than a single syringe, may be used and operated simultaneously. In this case, the multiple syringes can take samples from several or all of the microplate position.

It is further known for the syringe or syringes in an HPLC system to undergo a cleaning step between injections, consisting of rinsing the syringe with one or more solvents. It is further known that devices performing separation-based chemical analyses may additionally or even principally perform other chemical functions, such as reaction, filtration, purification, fractionation, or measurement of other properties, in addition to chemical analysis. It is further known that each sample in an HPLC system may also undergo subsequent further chemical analysis in a separate instrument, such as a mass spectrometer.

Several disadvantages exist with conventional multi-BPLC systems, however. For example, the quality of the chromatographic measurement in traditional HPLC equipment may be negatively impacted by the transfer of the sample to the sampling valve (e.g., valve 3 in FIG. 1). Either a moving syringe or a relatively long sample delivery tube is required to deliver the aliquot sample from the sample well to the sampling valve inlet (port 6 in FIG. 1). In this syringe or delivery tube, however, the flow of sample can spread out, resulting in a lower-quality chromatographic separation. Conventional multi-HPLC systems further tend to be overly large, complex, and unwieldy, especially when there are more than 4 columns, since there is little or no sharing of common hardware. Some systems fail to allow the taking of liquid samples from all of the wells of a microtiter plate. Others fail to permit simultaneous multiple injection of samples into the measurement columns, or fail to perform simultaneous detection on the flow from multiple columns.

Recently, integrated multi-column chromatographic instruments based on microfluidic technology have become available. These instruments, such as those from Nanostream and Eksigent, provide “nanoLC”, or liquid chromatography where the flow rates and volumes of sample injected are very much lower than with more conventional liquid chromatography. See, e.g., C. M. Harris, “Shrinking the LC Landscape”, Analytical Chemistry, vol. 75, pages 65A-69A, 2003. Such nanoLC systems typically include multiple columns that are combined together into an inseparable unit. All the columns must be replaced when only one needs to be replaced. Moreover, the column assemblies are only available from the instrument manufacturer, so that a unique column type developed by another manufacturer cannot be used in these instruments. In addition, the very small sample size, low column flow and non-standard columns of these instruments mean that an analyst with a validated and approved method, as by a government agency such as the U.S. Food and Drug Administration, must repeat the extensive work needed to achieve validation and approval of the method in order to use the nanoLC instrument.

Many multi-channel separation instruments have been adapted to samples in microtiter plates, where the instruments are based on electrophoresis rather than chromatography. The instruments are typically fully integrated with the microtiter plates, and have simultaneous injection and detection. Existing electrophoretic instruments, however, typically do not use an integrated sample injection system, wherein the sample volume is determined by a fixed-volume sample reservoir. Furthermore, these electrophoretic instruments are limited to very small samples and restricted to only certain kinds of chemical samples.

It would therefore be desirable to provide a multi-HPLC system that is simple and compact and that does not require a moveable sampling syringe or long sample delivery tube. It is further desirable to provide a multi-HPLC system that is capable of processing all of the wells in a microtiter plate. It is further desirable to provide a multi-HPLC system that simultaneously samples, separates and detects multiple samples. It is further desirable to provide a multi-HPLC system having individually replaceable measurement columns that may be inexpensively replaced and that comply with industry standards for HPLC measuring columns.

### SUMMARY OF THE INVENTION

The present invention solves these and other problems with conventional HPLC systems by providing a series of sampling devices that are small enough to be mounted in an array over a microtiter plate of standard size. In accordance with the invention, each sampling device can communicate with a well of the microtiter plate simultaneously, and in one or more cycles of operation, all of the samples in the wells in the microtiter place can be chemically analyzed. In accordance with the invention, the functions of valve actuator, sampling valve, syringe pump, and transfer device are all integrated into a single injector mounted at the end of the chromatographic column. The combination of the injector, chromatographic column, detector and auxiliary tubing and conduits needed to support the operation, all fit into sufficiently small space so that multiple combinations can be mounted side by side, and simultaneously service multiple chemical samples in a row of the microtiter plate.

More particularly, the invention provides a method and apparatus for transferring one or more liquid samples in one or more sample containers to one or more measurement devices, comprising the steps of, and means for, (a) opening a first valve communicating a first sample container with a first sample reservoir; (b) drawing a first liquid sample from the first sample container through the first valve into the first sample reservoir; (c) closing the first valve; (d) pumping the first liquid sample from the first sample reservoir into the first measurement device.

The invention further provides an assembly suitable for use in a separation-based measurement device, comprising a housing having an interior chamber connected to a sample inlet, a sample outlet, and a reservoir input/output port, a valve seal located between said sample inlet and said chamber; a hollow needle slideably mounted through said valve seal into said chamber; and a valve ball within said chamber, connected to the end of said hollow needle; whereby a mechanical pressure on the hollow needle tends to remove said valve ball from said valve seal, thereby creating a liquid flow passage through the hollow needle, past the valve ball and seal, to the interior chamber.

The invention still further provides a multiple-column separation-based analyzer, comprising: a support and two or more measurement assemblies mounted on said support. Each measurement assembly respectively comprises an interior chamber, connected to a sample inlet, a sample outlet, and a reservoir input/output port, a valve seal located between said sample inlet and said chamber; a hollow needle slideably mounted through said valve seal into said chamber; a valve ball within said chamber, connected to the end of said hollow needle, whereby a mechanical pressure on the hollow needle tends to remove said valve ball from said valve seal, thereby creating a liquid flow passage through the hollow needle, past the valve ball and seal, to the interior chamber; a sample reservoir connected to said reservoir input/output port; and a chromatographic or electrophoretic column connected to said sample outlet.

### BRIEF DESCRIPTION OF THE DRAWINGS

FIG. 1, discussed above, shows a schematic diagram of a conventional HPLC system.

FIG. 2 is a block diagram depicting an exemplary HPLC system in accordance with the present invention, including an injector, a column, and a hollow needle.

FIG. 3 is a cross-sectional view of an injector suitable for use in the present invention.

FIG. 4 is an isometric view of an exemplary single-row multi-HPLC system in accordance with the present invention.

FIG. 5 is an isometric view of an exemplary multiple-row multi-HPLC system in accordance with the present invention.

FIG. 6 is a cross-sectional view of an alternative embodiment of a hollow needle suitable for drawing a liquid sample from a particular location in a well of a microtiter plate in accordance with the present invention.

FIG. 7 is an isometric view of the multiple-row multi-HPLC system of FIG. 5, further including a microtiter plate for device washing and rinsing.

FIG. 8 is an isometric view of an exemplary two-injector device including discrete tubing lengths and Tee connectors in accordance with the present invention.

FIG. 9A is an isometric view of an alternative embodiment of a multi-HPLC system in accordance with the invention, including a sample tube block having shared flow paths in accordance with the invention.

FIG. 9B is a cross-sectional view of the multi-HPLC system depicted in FIG. 9A.

FIG. 10 is a cross-sectional view of an alternative embodiment of a multi-HPLC system in accordance with the invention, including a sample tube block having individual source paths and shared aspirating paths.

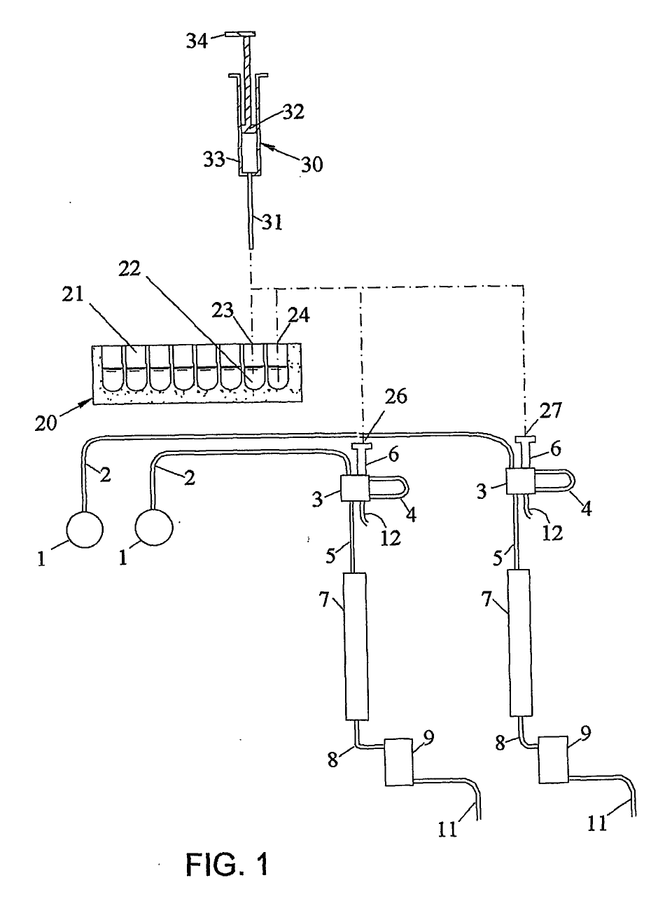

### DETAILED DESCRIPTION OF THE PREFERRED EMBODIMENTS

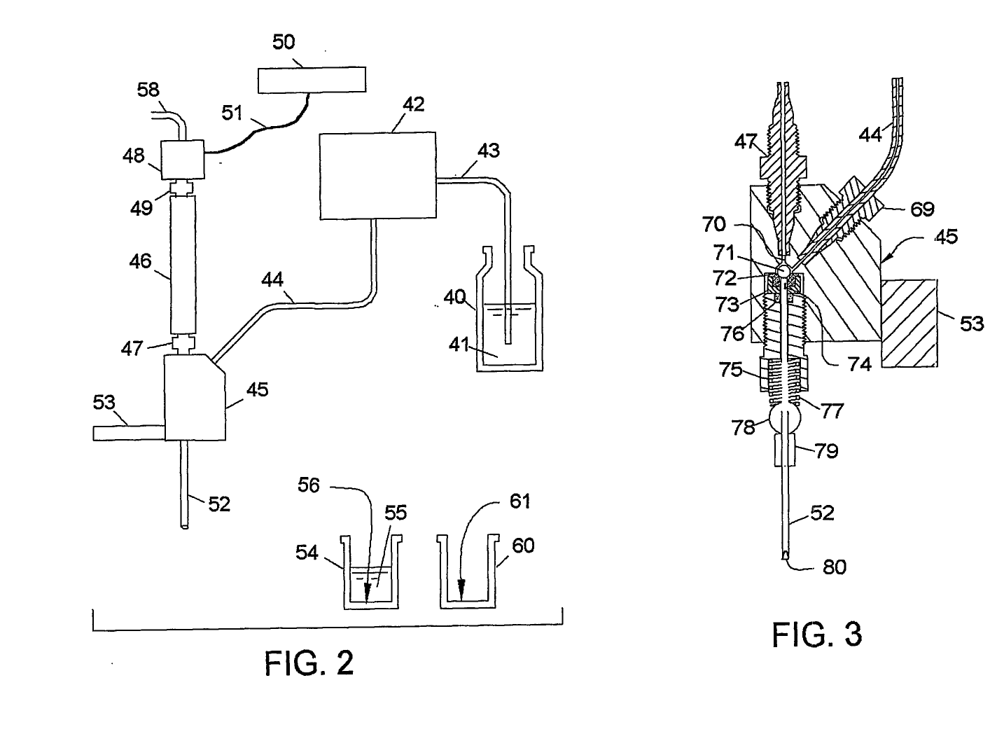

FIG. 2 shows a liquid chromatograph that incorporates the injector according to this invention. A reservoir 40 contains a liquid 41, used as the mobile phase for the liquid chromatographic process. A pump 42 withdraws said liquid 41 through a liquid supply tube 43, which is connected both to the reservoir 40 and to the pump 42. The pump 42 also delivers the liquid 41 to the injector 45 though a tube 44, which is connected both to the pump 42 and to the injector 45. The liquid 41 flows through the injector 45 and then to a chromatographic column 46 though an adaptor fitting 47.

From the chromatographic column 46 the liquid 41 flows into a detector 48 through a detector adaptor fitting 49. By processes well known to those skilled in the art, continuous chemical measurements are made by the detector on any chemicals contained in the detector 48 by the flow of liquid 41. An electronic readout of these measurements is carried to a computer 50 though a cable 51. Liquid flows out of the detector 48 though vent tube 58.

In a preferred embodiment, the injector 45 is attached to an actuator 53 can move the injector 45 to a container 54 for the purpose of taking a sample of a liquid chemical 55 contained therein. In accordance with the invention, injector 45 also contains a hollow needle 52 and a mechanically activated valve. The actuator moves the injector 45 over the container 54 and lowers the injector 45 so that the needle 52 enters the container 54 and presses against the container bottom 56. This causes the needle 52 to move upward within the injector 45, opening the valve and creating a passage between the needle 52 and the tube 44.

In operation, a sample of the liquid chemical 55 is introduced onto the column 46 in several steps.

(a) The liquid pumping system 42 interrupts the flow of liquid to the injector, and waits for a time sufficient for the liquid pressure within the injector 45 to drop below a low value convenient for introducing a sample, e.g., preferably less than about 600 p.s.i., and more preferably less than about 500 p.s.i.

(b) The actuator 53 moves the injector 45 to a position over the container 54 and lowers the injector 45 so that the needle 52 presses against the container bottom 56. This movement opens a passage from the chemical 55 through the needle 52 through the injector 45 to the tube 44.

(c) The pump 42 aspirates a certain amount of liquid out of tube 44 into pump 42. This in turn sucks liquid out of the sample container 54 throgh the needle 52 through the injector 45 and into said tube 44. During this process, a negligible amount of liquid is also sucked out of column 46 and column adaptor 47, but the amount of this liquid flow is much less than the flow from the container 54 since the resistance to flow within the column 46 is much higher than the resistance to flow within the needle 52. Pump 42 preferably provides an aspiration pressure greater than the residual pressure remaining after step (a) above.

(d) Once the desired amount of liquid sample from the chemical 55 has entered the tube 44 the actuator 53 raises the injector 45 from the container 54 so that the needle 52 no longer holds open a passage from the needle 52 to the tube 44.

(e) The liquid pumping system 42 resumes delivery of liquid through tube 44 successively into the injector 45 column adaptor fitting 47 column 46 detector 48 and vent tube 58. This flow of liquid carries the sample deposited in tube 44 into the column, for the purpose of chromatographic separation and detection of the constituents of the liquid chemical 55 as is well known to those skilled in the art. If a high-pressure liquid chromatograph measurement is required, pump 42 preferably should be capable of producing a pressure that is preferably between 1000-8000 p.s.i., more preferably between 3000-5500 p.s.i., and most preferably about 5000 p.s.i.

(f) When the chromatographic separation and detection of the sample is completed, the injector and needle are rinsed. The liquid pumping system 42 interrupts the flow of liquid to the injector 45 and the pressure drops. The actuator 53 moves the injector 45 to a rinsing container 60 where the needle 52 is pressed against the rinsing container bottom 61 thereby opening a passage between the needle 52 and the tube 44. Now the liquid pumping system sends liquid through the tube 44 successively through the injector 45 and needle 52. The amount of this flow is set to be sufficient to remove residues of the sample taken during the aspiration of sample from the liquid chemical 55 so that subsequent samples will be substantially free of contamination from previous samples.

FIG. 3 shows a further embodiment of the injector 45, which is mounted on a mechanical transporter 53. There is an upper liquid flow path, composed of the tube 44 connected to an injector body 45 with a tube fitting 69. The tube 44 is capable of sustaining the high pressures typical of HPLC, e.g., from 1000-8000 p.s.i., and has sufficient internal volume to contain the volume of sample liquid used for chromatography, such as 10 microliters.

The flow path includes a flow passage 70 within the injector body 45. The flow passage 70 is limited to a very small volume, with all parts well-swept by the liquid flow, so that when liquid samples are transferred to the column through the flow passage 70, there is no broadening of the chromatographic output due to dispersion of the sample while in the flow passage 70. The flow passage 70 communicates with an adaptor fitting 47. During operation, the tube 44 conducts a solvent liquid into the injector body 45. The solvent liquid flows through the flow passage 70 and then through the adaptor fitting 47 and into the column.

A ball 71 makes an intermittent seal against a valve seat 72. The ball 71 is rigidly attached to a hollow needle 52. The ball 71 is sufficiently round, smooth and concentric with respect to the hollow needle 52 to serve as a high-pressure seal, in combination with the valve seat 72.

The valve seat 72 is designed to form a high-pressure seal with ball 71. So it is either hard and very smooth or somewhat smooth and resilient, as is necessary in forming a high-pressure seal. The seal between the ball 71 and value seat 72 is suitable for intermittent operations, with many thousands of cycles before replacement, and can seal against the high pressures typical in HPLC, e.g., 1000-8000 p.s.i.

The hollow needle 52 has a bottom opening 80 communicating with a top opening 74. The hollow needle 52 is sufficiently narrow near the bottom opening, so that the hollow needle can easily be positioned within a well in a microtiter plate. In operation, a mechanical transporter 53 moves the injector 45 against a microtiter plate, so that the hollow needle 52 is positioned within a well of the microtiter place, and is pressed against the bottom of said well to open the seal of the ball 71. The hollow needle 52 is sufficiently rigid that it will not buckle when pressed against the bottom of the well.

The hollow needle 52 is positioned so that it penetrates a central hole in the valve seat 72, and it is spring loaded by spring 77 to pull the ball 71 against the valve seat 72, so that said ball 71 and said valve seat 72 form a liquid-tight seal.

In operation, the valve seat 72 is mounted in the injector body 45 and pressed against the injector body 45, forming a seal. The two seals, between the ball 71 and the valve seat 72, and between the valve seat 72 and the injector body 45, prevent flow from the flow passage 70 from entering the hollow needle 52.

The combination of the ball 71, hollow needle 52, valve seat 72, and spring mounted into the injector nut 75. The valve seat 72 is first mounted in or next to a back ferrule 73, which is in turn pressed against the injector nut 75. The injector nut 75 is a threaded part, designed to be attached to the injector body 49 for the purpose of supporting the ball 71, valve seat 72, and hollow needle 52. The back ferrule 73 prevents torque being applied to the valve seat 72 when it is being sealed against the injector body 49.

The ball 71 is positioned against the valve seat 72, so that the hollow needle 52 penetrates the valve seat 72, the back ferrule 73, and the injector nut 75, and protrudes beyond the far edge of the injector nut 75. The spring 77 is mounted around the hollow needle 52 from the far side and is compressed between the injector nut 75 and a collar 78 and a crimp 79. The combination of collar 78 and crimp 79 are attached to the hollow needle 52 in such a way that the compressed spring 77 applies a force to the hollow needle 52 and thence to the ball 71, which induces the ball 71 to make a seal against the valve seat 72. For instance, with a 2 mm diameter ball, a force of 2 pounds is sufficient to make a seal. The crimp 79 may be attached to the hollow needle 52 by brazing, crimping, gluing, or by fitting into a groove in the hollow needle, as with a retaining ring, snap ring, or locking ring.

An O-ring 76 is mounted around the hollow needle 52 and between the injector nut 75 and the back ferrule 74. The O-ring 76 seals to the back ferrule 73. The outside of the hollow needle 52 is smooth so that it can f a sliding seal against the O-ring 76. Advantageously, O-ring 76 need only withstand lower pressures, such as about 500 p.s.i., since in normal operation, the high pressures used in HPLC are turned off before the ball 71 opens and exposes the O-ring 76 to the higher pressures that the ball 71 is designed to seal against.

The top opening 74 in the hollow needle 52 is located below the seal between the valve seat 72 and the ball 71 but above the seal between the hollow needle 52 and the back ferrule 73. The bottom opening 80 allows sample to enter from a well, but the edge of the hollow needle 52 around the bottom opening must be robust enough to support pressure between the well bottom and the hollow needle 52. The space around the hollow needle 52 below the ball 71 and above O-ring 76 needs to have minimal volume and be easily cleaned by rinsing, so that residual liquid from one sample may be prevented from substantially contaminating a subsequent sample.

Preferably, the clearance between the hollow needle 52 and injector nut 76 is sufficient to allow freely sliding relative motion but narrow enough to prevent the tilt of the hollow needle sufficient to interfere with the hollow needle passing into a well in a microtiter plate.

When multiple injectors 45 are installed together, the flow characteristics, especially in the hollow needles 52 and the tubes 44 preferably are substantially the same, so that when sample is aspirated, and the samples enter the tubes, the flows will be substantially the same in each injector 54,and substantially the same amounts of samples will enter each tube.

The ball 71 is preferentially kept small, such as 2 mm in diameter, so that lower forces are required from the spring 77 to make a seal, and to minimize the volume of the flow passage 70, which is typically less than 10 microliters. The tube 44 should be narrow to minimize broadening of the sample distributions during chromatography, such as 0.1 to 0.5 mm diameter. The volume of the tube 44, however, needs to be sufficiently large to contain the largest sample injection volume, such as 20 microliters. The above numbers have been found suitable for a certain size of chromatography column, 2 mm diameter and 20 mm length, with a flow rate of 1 to 2 mL per minute. It will be appreciated by those skilled in the art that the above-mentioned dimensions should be scaled, when other chromatographic conditions are used, such as a chromatographic column of different diameter. For instance, with a 4.6 mm diameter chromatographic column, the volumetric dimensions should be about 10 times larger; with a 1 mm column, they should be about 10 times smaller.

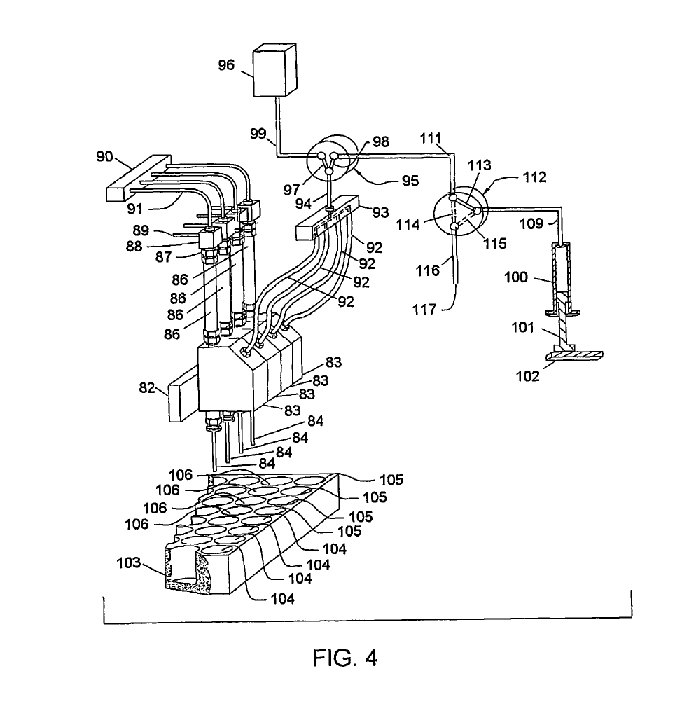

FIG. 4 shows the invention used for multi-channel chromatographic analysis of liquid chemical samples contained in a microtiter plate 103 which has a pattern of 96 wells that are arranged in a rectangular array of 8×12 wells, based on a unit cell of 9 by 9 mm square. Other versions of microtiter plates have 384 wells in a 16×24 array on 4.5 mm centers, or 1536 wells, in 32×48 array, on 2.25 mm centers.

Several columns 86 such as the four columns shown in FIG. 4 are mounted on a series of injectors 83. The injectors 83 may be fashioned out of separate parts, and mounted together as shown in FIG. 4, or machined in a common block. The injectors 83 are rigidly mounted onto a mechanical transporter 82. The spacing between the hollow needles 84 in said injectors is preferably 9 mm, in order to match the standard spacing between the wells of the microtiter plate 103.

The injectors 83 can each supply liquid to, and receive liquid from, tubes 92. These tubes 92 all connect to a union fitting 93, which then is connected to a supply tube 94.

Pump Selection Valve.

During chromatography, the liquid chromatography pump 96 through pump tube 99 supplies flow at high pressure to the injectors 83 and columns 86. The syringe pump 100 and syringe control valve 112 are generally not designed to withstand the pressures used in liquid chromatography, which can exceed 5000 p.s.i.

Therefore a pump selection valve 95 is interposed between the flow from the pump tube 99 and the supply tube 94. During chromatography, the pump selection valve 95 is in the “pump” position 97 permitting flow from the liquid chromatography pump 96. When the syringe pump 100 is in use, the pump selection valve 95 connects to said syringe pump 100 in place of the liquid chromatography pump 96 by switching to the “aspirate” position 98.

Syringe Control Valve.

The flow from the pump selection valve 95 through the aspiration tube 111 the syringe tube 109 to the syringe pump 100 goes through the syringe control valve 112 when said syringe control valve is in the “fill” valve position 113. Said valve 112 in its “vent” valve position 114 can divert this flow through the vent tube 116 to vent to waste 117 by. Said valve can also, it its “empty” valve position 115 can allow the syringe pump to empty to vent to waste 117.

Syringe Pump.

The syringe pump 100 has a syringe plunger 101 connected to a syringe driver 102. The syringe driver 102 can move the syringe plunger 101 with respect to the syringe pump 100 so that the syringe pump 100 can either aspirate liquid when the syringe plunger 101 is pulled out, or can deliver liquid, when the syringe plunger 101 is pushed in.

Some types of syringe pumps are designed for high pressures. In this case, the pump selection valve 95 can be replaced by a “Tee” connection between the two pump tubes 99 and the supply tube 94. Alternatively, one or more syringe pumps 100 can be adapted to serve as both the liquid chromatography pump and the pump used to aspirate and deliver samples.

Aspiration

In preparing for chromatographic injection, the mechanical transporter 82 moves the injectors 83 so that the hollow needles 84, which are incorporated into said injectors, simultaneously press against the bottom of a series of wells 104 in the microtiter plate 103. Then, with the pump control valve 95 in the “aspirate ” valve position 98 and the syringe control valve is in the “fill” valve position 113, the syringe pump 100, the syringe plunger 101 and syringe driver 102 cause liquid to be aspirated from the sample wells 104 through the injectors 83 into tubes 92.

Injection and Chromatographic Separation

When the mechanical transporter 82 moves the injectors 83 so that the hollow needles 84 no longer press against the bottom of a series of wells 104 the injectors 83 are no longer connected to the wells 104. When the pump control valve 95 is returned to the “pump” position 97 the flow is resumed from the liquid chromatography pump 96, through the pump selection valve 95 the supply tube 94 union fitting 93 tubes 92 injectors 83 and columns 86. Said flow carries the liquid samples left in tubes 92 and moves it into the columns 86 thereby injecting the sample into the column. As the flow continues, chromatographic separations take place in the columns 86. The flow through the columns then traverses the second adaptor fittings 87 to the detectors 88 where the passage of various chemical components within the flow is detected. The detectors 88 are connected to a detector controller 90 through detector cables 91.

Other operations

Several auxiliary operations are necessary in liquid chromatography, and that these can easily be performed with the device of FIG. 4. For example, the tubes 92 injectors 83 and the needles 84 can be rinsed with a rinsing liquid. This is often but not always the same liquid as is used for chromatography. The mechanical transporter 83 moves said injectors to a series of wells, used as rinse wells 105. The needles are pressed against the bottoms of the wells 105 in the same way as during aspiration. However, instead of aspirating sample, either the liquid chromatography pump or the syringe pump causes rinsing liquid to flow through tubes 92 injectors 83 and hollow needles 84 into the rinse wells 105. In addition, other manipulations of valves and pumps can be used to rinse aspiration tube 111 and syringe tube 109.

Series of Injections.

The device of FIG. 4, can inject from more than one series of samples wells 104. For instance, if the mechanical transporter 82 moves the injectors 83 to a second set of wells 106 then the contents of said second set of wells can be chromatographed. In this way, the contents of all or substantially all of the wells in the microtiter plate 103 can be chromatographed.

When a microtiter plate with a cell spacing of a half or one-quarter of the standard 9-mm cell spacing is used, the series of injectors, 9 mm apart, may still be used to chromatograph all the wells in the microtiter plate. For instance, with a 16-cell row in a 384 well plate, with 4.5 mm spacing, the device of FIG. 4 can inject and chromatographically separate samples from wells # 1, 3, 5 and 7, in the first row. In a second operation, with the mechanical transporter moved by 4.5 mm, the first-row wells # 2, 4, 6, and 8 can be processed. Then the mechanical transporter moves so that the device is aligned with wells 9, 11, 13, and 15. After a third movement, the wells at # 10, 12, 14, and 16 are processed. With a movement in the other axis, all of the wells in the other 23 columns can be processed.

While FIG. 4 shows four injectors 83, multiple analyses may readily be performed by another number of injectors, such as two, three, six, eight or twelve, where the number of injectors is an even divisor of the number of rows or of columns in the microtiter plate.

Multiple Rows of Injectors.

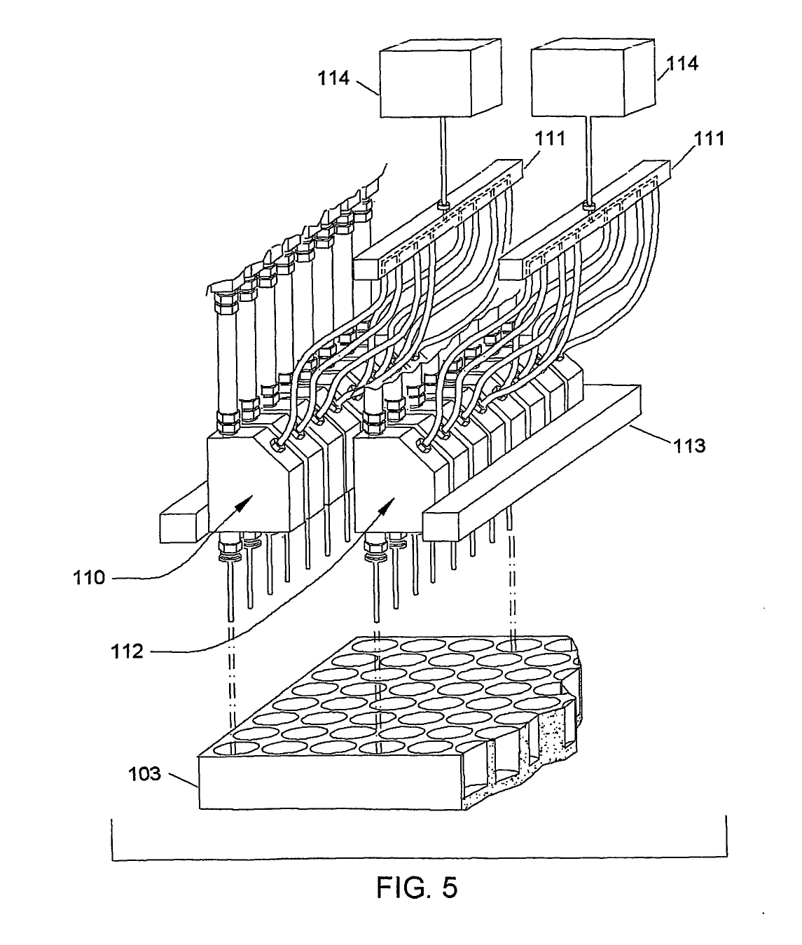

While FIG. 4 shows the injectors 83 arranged in a line, the injectors may be arranged in more than one line. For example, FIG. 5 shows a valuable realization of the invention that has an arrangement of two rows of eight injectors, with the spacing between the rows determined by the spacing of the wells. There are eight injectors in a first row 110 with the eight tubes connected into common union fitting 111. The spacing between the injectors is 9 mm. A second set of injectors is arranged into a second row 112. The second row 112 is spaced 27 mm from the first row which is triple the spacing between wells in the microtiter plate 103. The sixteen injectors are all mounted to a mechanical transporter 113. The mechanical transporter 113 can move the injectors down to press against the wells of the microtiter plate 103 in order to aspirate a liquid sample into each injector.

Two flow systems 114 are used, one for the first row 110 and the other for the second row 112. Alternatively, a single flow system may be used, or a larger number of flow systems. For instance, four flow systems could be used, each of which is connected to four injectors.

Alternative Injector Valve Embodiment

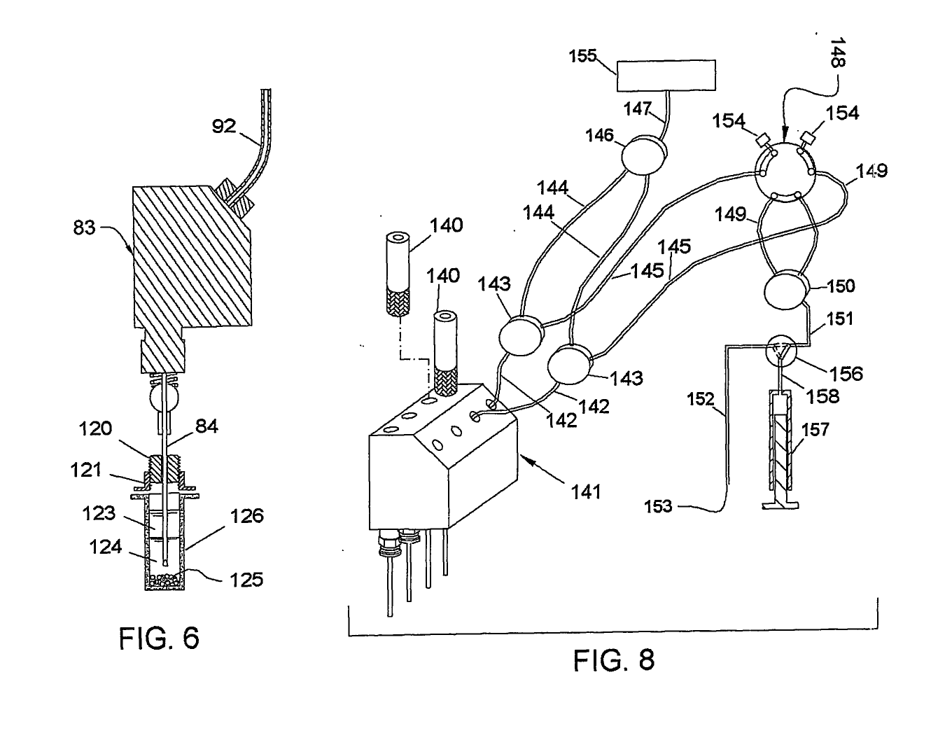

FIG. 6 shows an alternative embodiment of hollow needle 84 in injector 83. There may be cases where it is not desirable to press a hollow needle 84 against the bottom of a well 126. For instance, some samples may contain contamination by solid particles 125 which it would be disadvantageous to aspirate along with the liquid 124. In this case, it would be desirable to position the tip of the hollow needle 84 above the bottom of the well 126 during aspiration.

In FIG. 6, a flat boss 121 is attached to the hollow needle 84. The flat boss is attached by means of a threaded collar 120, which allows the position of the flat boss along the hollow needle 84 to be adjusted. When the needle is inserted into the well 126 the flat boss 121 contacts the upper edge of the well 126 before said hollow needle contacts the bottom of said well. The pressure of this contact opens the ball valve. One advantage of this variation is to provide for use with samples known to have immiscible liquid phases 123 and 124 where the aspirating position of the hollow needle 84 can be adjusted to sample from a particular liquid phase 124.

Washing Station

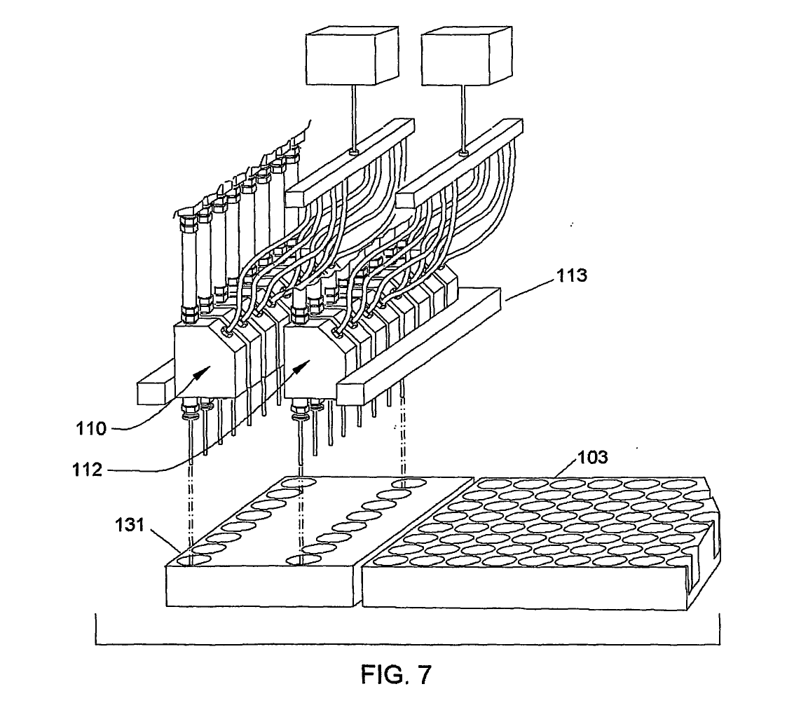

In FIG. 4, some of the wells 105 in a microtiter plate 103 were dedicated to being used as a rinsing station for the hollow needles 84. FIG. 7 shows an alternative design, which provides a rinsing station, separate from the wells in the microtiter plate. Two rows of samplers 110 and 112 are rigidly mounted on a common transporter 113. The transporter 113 not only can move the injectors 110 and 112 to different positions over the microtiter plate 103 but can also move the injectors to a separate washing station 131, which has receiving wells disposed to permit the injectors to press down on the washing station 131 and to dispense waste rinsing liquid into the receiving wells. In addition, this arrangement may be used to aspirate a washing liquid from the washing station 131.

Control of Injection Volume.

With further reference to the embodiment shown in FIG. 4, it is highly preferable for sample to be aspirated only into the tubes 92, not into the union fitting 93 or supply tube 94. Otherwise, when flow is resumed from the liquid chromatography pump 96, a residual mixture from all the aspirated samples will be introduced into each column 86. However, if samples are aspirated only part way through tube 92, it may be difficult to control the volume of sample.

In FIG. 8, the difficulty of controlling the sample volume is addressed. FIG. 8 shows a two-channel system, with columns 140 attached to an injector block 141, which contains several injectors, two of which are connected. Sample tubes 142 are of definite volume, and will determine the volume of the injection. Flow from the LC Pump 155 goes through the solvent delivery tube 147, the solvent tee 146 and the two sample-solvent tubes 144 to the sample tees 143. The sample tees 143 also connect to the syringe pump 157 through the aspiration tubes 145, two-position valve 154, valve tubes 149, syringe tee 150, syringe tube 151, syringe valve 156 and tube 158.

In this realization, the flow from the LC Pump 155 always flows during sample aspiration. This requires that the rate of aspiration by the syringe pump 157 is higher than the flow rate from said LC pump. Unlike the realization of FIG. 4, sample is aspirated until the flow of sample over fills the sample tubes 142 and flows into the aspiration tubes 145 or even further. After sufficient sample has been aspirated, the injector block 141 is raised, so that the valves within the injector block close. This ends the aspiration of sample.

The flow from the LC pump 155 continues, and is directed through the aspiration tubes 145 ultimately to the syringe valve 156, where it is either aspirated into the syringe pump 157 or directed to the vent tube 152 to vent to waste 153. This process rinses any remaining sample in the sample tees 146, aspiration tubes 145 and other parts of the flow system.

Next, the two-position valve 148 switches, so that the syringe pump 157 and syringe valve 156 are isolated from the aspiration tubes 145. Now the flow from the LC Pump 155 has nowhere to go except through the columns 140. So the flow sweeps the sample that resides in the sample tubes into the columns. Note that the volume of each sample is precisely set by the volume of each sample tube, along with a small, defined volume in the injector block. In this way, the two problems of a defined sample volume, and cross-sample contamination are eliminated.

The following components are suitable for use with the invention:

| Identifier/Name | | Description |
|---|---|---|
| 140 | column | Thermo Hypersil-Keystone Javelin column, |
| | | 2.1 mm id, 20 mm long, 5-micron packing, |
| | | coated with Beta Basic C18 |
| 141 | injector block | — |
| 142 | sample tube | 8.3 cm long, 0.25 mm id. PEEK |
| 143 | sample tee, | three way, for 1/16″ tubing, 10-32 |
| | | fittings, PEEK |
| 146 | solvent tee | three way, for 1/16″ tubing, 10-32 |
| | | fittings, PEEK |
| 150 | syringe tee | three way, for 1/16″ tubing, 10-32 |
| | | fittings, PEEK |
| Other Tubes | | 0.5 mm id, PEEK, length as follows: |
| 144 | solvent-sample tube | 30 cm long |
| 145 | aspiration tube | 30 cm long |
| 147 | solvent delivery | 25 cm long |
| | tube | |
| 149 | valve tube | 20 cm long |
| 151 | syringe tube | 30 cm long |
| 158 | tube | 30 cm long |
| 148 | two-position valve | Valco, Cheminert, rotary valve, 6-port |
| 152 | vent tube | 17 cm long, 1/16″ o.d. PTFE |
| 153 | vent to waste | — |
| 154 | plug | — |
| 155 | LC Pump | Pharmacia “Bromma” 2249 Gradient |
| | | Pump |
| 156 | syringe valve and | both part of Cavro XP3000 modular digital |
| 157 | syringe pump: | pump |

Integrated Sample Tubes

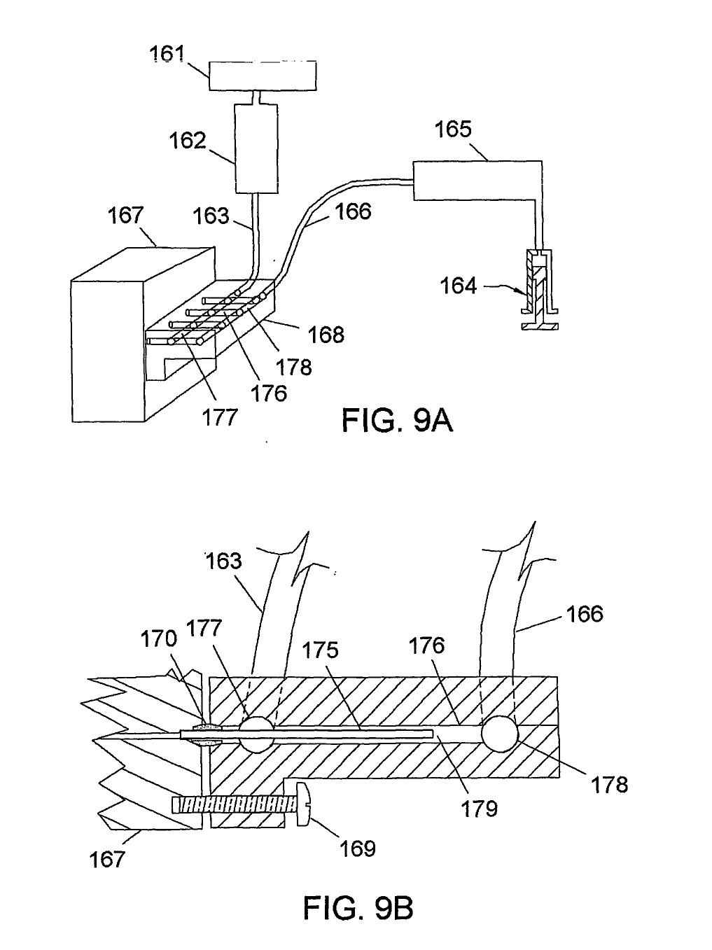

FIGS. 9A and 9B show another realization of the invention. Here the sample tubes have been incorporated into a sample tube block. In FIG. 9A the sample tube block 168 is rigidly fastened to the injector block 167 by a fastener 169. The sample tube block has three sets of interconnected channels lying in a plane. Multiple cross channels 176 contain the sample tubes 175. The sample tubes meet with or penetrate into the injector block 167. Sample tube seals 170 seal the sample tubes to the injector block 176 and to the sample tube block 168. They also seal between the injector block 167 and the sample tube block 168.

Each cross channel 176 is intercepted by a solvent channel 177, which in turn communicates with the solvent-sample tube 163, a solvent flow circuit 162 and an LC Pump 161. Note that the solvent channel 177 intercepts the cross channel 176 between the sample tube seal 170 and the mixing point 179 where the flow from the LC Pump, through the solvent channel 177 meets with the flow to or from the syringe pump 164 through the aspiration channel 178.

Each cross channel 176 is intercepted by the aspiration channel 178 which also connects to the aspiration tube 166 which connects to a syringe flow circuit 165 and thence to the syringe pump 164. Note that the aspiration channel 178 intercepts the cross channel 176 beyond the end of the sample tube 175 and the mixing point 179.

With this realization, sample can be aspirated through each sample tube 175 so that some sample flows past the mixing point 179 into the aspiration channel 178 and aspiration tube 166. The portion of this flow path past the mixing point 179 can be rinsed by flow from the LC pump 161 solvent-sample tube 163 solvent channel 177 and thence, along the outside of the sample tube 175 to the mixing point 179.

This realization does not depend on tees for the mixing point 179 as were used in FIG. 8 and permit the sample tube 175 and mixing point 179 to be made compactly and precisely, with little dead volume. It also has the advantage that, the volume of the sample tube 175 can be adjusted simply by changing the length or inside diameter of said sample tube with no change to other dimensions.

Unequal Column Flow

In FIG. 9A, where a source of flow is split between columns, a possible difficulty is that the flows may not be the same in each column. This difference in flows may cause solvent flows from one cross channel 176 and sample tube 177 where the column flow is lower, to flow over to another cross channel, where the column flow is higher.

One way this difficulty can be eliminated or greatly reduced is by arranging, during chromatography, to have some bleed flow out of the sample tube block 168 into the aspiration tube 166. For instance, a tube with restricted flow can be mounted in the syringe flow circuit 165 so that said tube can be connected from the aspirator tube to vent to waste, thereby permitting a low bleed flow to sweep the aspirator channel 178 and aspirator tube 166. Alternatively, the bleed flow can flow in the alternative direction. With this arrangement, a difference in flow in a column is accommodated by adjustments in the bleed flow.

Independent Flow Sources

Another realization uses independent flow sources for each column, but still uses a common syringe pump for aspiration. This permits independent control over the chromatographic flow in each channel.

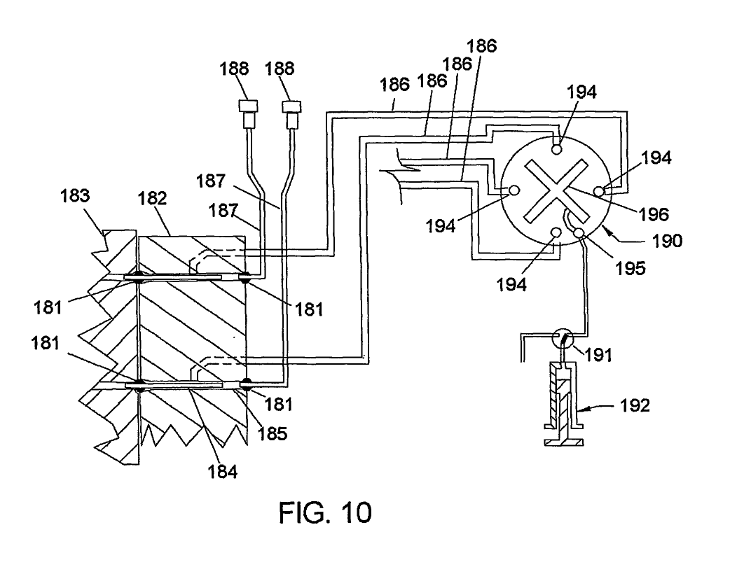

FIG. 10 shows a sample tube block 182 mounted on an injection block 183 with sample tubes 184 located in cross channels 185. Instead of a single solvent-sample tube feeding connecting to multiple cross channels, as in FIG. 9, in FIG. 10 there are multiple solvent-sample tubes 187 each of which is joined to a cross channel 185. There are multiple aspiration tubes 186 each of which is joined to a cross channel 185. Seals 181 are used to seal the various components. Each solvent-sample tube 187 is connected to a solvent inlet port 188 where a source of solvent flow can be connected.

Each aspiration tube 186 connects to a separate port 194 on a valve 190. The valve 190 in one position closes off the aspiration tubes 186. In another position, said valve connects each aspiration tube 186 to another valve port 195 which connects to a syringe valve 191 and syringe pump 192. For example, the valve 190 may be a rotary valve, with a rotor with a cross-shaped groove 196 which can simultaneously connect the separate ports 194 to another valve port 195.

This realization permits totally independent control of the chromatographic flow in each column, since independent sources of chromatographic flow are connected to each column, via solvent inlet ports 188. During aspiration of samples, only a single syringe pump 191 is needed. Even if the flows in the sample tubes 184 are not identical during aspiration, this realization permits substantially known and equal injection volumes, since the sample tubes 184 can be overfilled, and the excess sample can be washed out of the aspiration tubes 186 by flow of solvent, through the aspiration tubes 186 and the valve 190.

Flow Normalization

Beneficially, the flow and parameters of the injectors and columns in the present invention are the same or very similar. It is an advantage of this invention that it takes advantage of this similarity to control flows to each column simply by spitting the flow into several nearly equal flows, relying on the similarity of the column flow resistances to give nearly equal flows. Since the flows may not be identical, however, software adjustments may used to compensate for the small differences.

As is commonly done in liquid chromatographic or electrophoretic instruments, in this invention the output of the each detector connected to a column produces a series of data-point pairs, T and S, which record the time of the measurement, T, and the signal level, S. A separate series of (T,S) pairs is produced for each column.

In the data processing step, these series of data-point pairs are analyzed for the presence of chemical compounds, as indicated by an increase in signal level, S, over several measurements. The response of the chemical compound is recorded as the Retention Time, which is the time of the maximum response, and the Area, which is the sum of the signal levels showing a response, with the baseline response subtracted out.

In order to correct for differences in the flow between columns, as well as for other differences that affect the times, T, a correction is made to each data-point series, prior to the determination of Retention Times and Areas of the chemical compounds.

A chemical sample containing at least two known compounds is analyzed by all of the columns. The first calibration compound is virtually unretained by the columns, and transits each column at substantially the same rate as a segment of the solvent flow. For each column, this time, T1, is measured. The retention time of the first compound under standard conditions, T1std, is known. The second compound is retained by the column for a time that is substantially longer than T1. The retention time of the second compound, T2, is measured. The retention time of the second compound under standard conditions, T2std, is known.

A flow-normalization is then made to the chromatograms, that is, sereies of data-pairs (T, S) of samples containing mixtures of unknown compounds. In each data-pair, (T, S), each time, T, is replaced by a corrected value, T′, where T′=−(T1−T1std)+T*(T2std−T1std)/(T2−T1). In this way, the flow normalization correction terms, (T1−T1std) and (T2std −T1std)/(T2−T1), may be customized for each column.

Once the chromatograms have been flow-normalized, their Retention Times and Area are determined in the normal way. It is noted that normal chromatographic signal processing also calibrates and corrects for variations in signal level, S, based on a calibration sample. This normal procedure can easily be merged with the flow-normalization process.

It has been found that the Retention Times, T1 and T2, for a calibration sample normally vary slowly over many hours, so that it is feasible and practical to run a flow normalization measurement a few times a day, while processing many sets of unknown samples mixtures in between. The combination of flow normalization and signal-level calibration may also be used to also compensate for other environmental or operational changes that may occur over the course of a day, week or other period of time.

Advantages of the Invention

The present invention described above has numerous benefits in comparison with conventional HPLC systems. First, whereas many conventional HPLC systems require successive sample injection steps to process multiple samples, the HPLC system of the present invention allows multiple samples to be injected into a chromatography measurement device (e.g., chromatographic column) simultaneously, in a single step. This simultaneous processing reduces the duration and cost of analyses on multiple samples.

Second, whereas many conventional HPLC systems require a separate sample loading and transporting step, typically involving the use of a syringe to aspirate a liquid sample and transport it to the input port of an injector valve, the present invention allows the liquid samples to be aspirated and immediately analyzed, without a transport step. This improvement results in a lowered process time and in a higher measurement quality.

Third, in conventional HPLC systems, variations in flow, viscosity, and pressure make it difficult to inject a known volume. Conventional injectors therefore fill a known volume with the sample liquid at low pressure, and then insert the volume into a high-pressure flow path. In the multiplexed operation according to the invention, the physical conditions of flow, viscosity, and pressure are much more controlled. Therefore it is possible to use a known volume (created by a device like a syringe pump) to set the total volume, and use the uniformity of the columns to allocate this volume among the injection volumes of each injector.

Fourth, in a conventional injection valve, an electrical solenoid is commonly used to switch the state of the injection valve. Because the multiplexed chromatography in accordance with the present invention uses a known physical environment (taking samples from a microtiter plate), the need for an electrical solenoid can be avoided through the use of the pressure-sensitive injection needle described above.

While the invention has been described with reference to the preferred embodiment thereof, it will be appreciated by those of ordinary skill in the art that modifications can be made to the structure and elements of the invention without departing form the spirit and scope of the invention as a whole.

1. A method for transferring one or more liquid samples in one or more sample containers to one or more measurement devices, comprising the steps of:
a. opening a first valve communicating a first sample container with a first sample reservoir;
b. drawing a first liquid sample from the first sample container through the first valve into the first sample reservoir;
c. closing the first valve; and
d. pumping the first liquid sample from the first sample reservoir into the first measurement device.

2. The method of claim 1, wherein the first valve is a normally-closed, spring-loaded ball valve, and wherein said step of opening a first valve further comprises the step of:
e. applying a first opening force to the ball of the first valve.

3. The method of claim 2, wherein said step of applying a first opening force comprises the steps of:
f. bringing a first needle in contact with a first substantially immobile surface, wherein an end of the first needle is in contact with the ball of the first valve, such that the pressure of the surface against the first needle is communicated to the ball.

4. The method of claim 3, wherein the first substantially immobile surface is the bottom of the first sample container.

5. The method of claim 3, wherein the first substantially immobile surface is an upper surface of the first sample container and wherein the first needle includes a first spacer that contacts the upper surface of the first sample container.

6. The method of claim 2, wherein said step c. of closing the first valve comprises the step of
f. withdrawing the first opening force from the ball of the first valve.

7. The method of claim 6, wherein said step f. of withdrawing comprises the step of
g. removing the first needle from contact with the first substantially immobile surface.

8. The method of claim 1, further comprising the step of analyzing the first liquid sample by a liquid chromatograph column or electrophoretic column.

9. The method of claim 8, wherein the liquid chromatographic column or electrophoretic column is directly attached to the first valve with no intervening tubing.

10. The method of claim 1, wherein the step d. of pumping is performed at a pressure between about 1000 p.s.i. and 8000 p.s.i.

11. The method of claim 1, wherein the step b. of drawing a first liquid sample comprises the step of:
g. withdrawing the plunger of a syringe from the chamber of the syringe, wherein the chamber communicates with the first sample reservoir.

12. The method of claim 1, further comprising the steps of:
e. translating the first valve to communicate between a rinsing container having a rinsing sample and the first sample reservoir;
f. opening the first valve;
g. pumping a rinsing sample through the first sample reservoir and the first valve into the rinsing container; and
h. closing the first valve.

13. The method of claim 1, further comprising the steps of
e. opening a second valve communicating a second sample container with a second sample reservoir, wherein the second valve is attached to the first valve;
f. drawing a second liquid sample from the second sample container through the second valve into the second sample reservoir;
g. closing the second valve;
h. pumping the second liquid sample from the second sample reservoir into the second measurement device.

14. The method of claim 13, wherein the steps e, f, g, and h of opening a second valve, drawing a second liquid sample, closing the second valve, and pumping the second liquid sample are performed at substantially the same time as the steps a, b, c, and d of opening a first valve, drawing a first liquid sample, closing the first valve, and pumping the first liquid sample, respectively.

15. An apparatus for transferring one or more liquid samples in one or more sample containers to one or more measurement devices, comprising:
a. a means for opening a first valve communicating a first sample container with a first sample reservoir;
b. a means for drawing a first liquid sample from the first sample container through the first valve into the first sample reservoir;
c. a means for closing the first valve;
d. a means for pumping the first liquid sample from the first sample reservoir into the first measurement device.

16. The apparatus of claim 15, wherein the first valve is a normally-closed, spring-loaded ball valve, and wherein said means for opening a first valve further comprises:
e. a means for applying a first opening force to the ball of the first valve.

17. The apparatus of claim 16, wherein said means for applying a first opening force comprises:
f. a means for bringing a first needle in contact with a first substantially immobile surface, wherein an end of the first needle is in contact with the ball of the first valve, such that the pressure of the surface against the first needle is communicated to the ball.

18. The apparatus of claim 17, wherein the first substantially immobile surface is the bottom of the first sample container.

19. The apparatus of claim 17, wherein the first substantially immobile surface is an upper surface of the first sample container and wherein the first needle includes a first spacer that contacts the upper surface of the first sample container.

20. The apparatus of claim 16, wherein said means for closing the first valve comprises:
f. a means for withdrawing the first opening force from the ball of the first valve.

21. The apparatus of claim 20, wherein said means for withdrawing comprises:
g. a means for removing the first needle from contact with the first substantially immobile surface.

22. The apparatus of claim 15, further comprising:
e. a means for analyzing the first liquid sample by a liquid chromatograph column or electrophoretic column.

23. The method of claim 22, wherein the liquid chromatographic column or electrophoretic column is directly attached to the first valve with no intervening tubing.

24. The apparatus of claim 15, wherein the means for pumping is capable of producing a pressure between about 1000 p.s.i. and 8000 p.s.i.

25. The apparatus of claim 15, wherein the means for drawing a first liquid sample comprises:
g. a means for withdrawing the plunger of a syringe from the chamber of the syringe, wherein the chamber communicates with the first sample reservoir.

26. The apparatus of claim 15, further comprising:
e. a means for translating the first valve to communicate between a rinsing container having a rinsing sample and the first sample reservoir;
f. a means for opening the first valve;
g. a means for pumping a rinsing flow through the first sample reservoir and the first valve into the rinsing container; and
h. closing the first valve.

27. The apparatus of claim 15, further comprising:
e. a means for opening a second valve communicating a second sample container with a second sample reservoir, wherein said second valve is attached to said first valve;
f. a means for drawing a second liquid sample from the second sample container through the second valve into the second sample reservoir;
g. a means for closing the second valve;
h. a means for pumping the second liquid sample from the second sample reservoir into the second measurement device.

28. The apparatus of claim 27, wherein the means for opening a second valve, drawing a second liquid sample, closing the second valve, and pumping the second liquid sample operate at substantially the same time as the means for opening a first valve, drawing a first liquid sample, closing the first valve, and pumping the first liquid sample, respectively.

29. An assembly suitable for use in a separation-based measurement device, comprising:
a. a housing having an interior chamber connected to a sample inlet, a sample outlet, and a reservoir input/output port;
b. a valve seal located between said sample inlet and said chamber;
c. a hollow needle slideably mounted through said valve seal into said chamber; and
d. a valve ball within said chamber, connected to the end of said hollow needle;
e. whereby a mechanical pressure on the hollow needle tends to remove said valve ball from said valve seal, thereby creating a liquid flow passage through the hollow needle, past the valve ball and seal, to the interior chamber.

30. The assembly of claim 29, further comprising:
f. a chromatographic or electrophoretic column connected to said sample outlet and rigidly attached to said housing.

31. The assembly of claim 29, further comprising:
f. a sample reservoir connected to said reservoir input/output port.

32. The assembly of claim 31, further comprising:
g. a syringe connected to said sample reservoir, capable of aspirating liquid from said hollow needle through said chamber into said sample reservoir.

33. The assembly of claim 31, further comprising:
g. a pump connected to said sample reservoir, capable of pumping liquid from said sample reservoir through said chromatographic or electrophoretic column.

34. A multiple-column separation-based analyzer, comprising:
a. one of a support and a housing;
b. two or more measurement assemblies mounted on said support or housing, each measurement assembly respectively comprising:
i. an interior chamber, connected to a sample inlet, a sample outlet, and a reservoir input/output port,
ii. a valve seal located between said sample inlet and said chamber;
iii. a hollow needle slideably mounted through said valve seal into said chamber;
iv. a valve ball within said chamber, connected to the end of said hollow needle, whereby a mechanical pressure on the hollow needle tends to remove said valve ball from said valve seal, thereby creating a liquid flow passage through the hollow needle, past the valve ball and seal, to the interior chamber;
v. a sample reservoir connected to said reservoir input/output port; and
vi. a chromatographic or electrophoretic column connected to said sample outlet.

35. The analyzer of claim 34, further comprising a motor mechanically linked to said support or housing, capable of translating said support or housing and said measurement assemblies.

36. The analyzer of claim 34, wherein said measurement assemblies are arranged in a rectangular array having two or more rows and at least one column.

37. The analyzer of claim 36, wherein the rectangular array has a number of rows equal to one of 2, 3, 4, 6, 8 and 12, and a number of columns equal to one of 1, 2, 3, 4, 6, 8, and 12.

38. The analyzer of claim 36, wherein the rectangular array has a unit cell spacing equal to integral multiples of 9 mm.

39. The analyzer of claim 34, wherein said two or more measurement assemblies are configured to operate at substantially the same time.

40. The analyzer of claim 34, further comprising:
c. a measurement surface capable of receiving a micro-titer plate having two or more wells containing two or more liquid samples to be measured;
d. wherein said two or more measurement assemblies are configured to simultaneously process at least two of said two or more liquid samples.

41. The analyzer of claim 40, wherein said motor is configured to move said two or more measurement assemblies first to a first set of said two or more wells in said micro-titer plate and then to a second set of said two or more wells in said micro-titer plate.
